(19) United States
(12) Patent Application Publication
(10) Pub. No.: US 2009/0280261 A1
(43) Pub. Date: Nov. 12, 2009

(54) USE OF A MATERIAL RESISTANT TO ATTACKS BY XYLOPHAGOUS INSECTS

(75) Inventor: Silham El Kasmi, L'Epine (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Lapeyre, Courbevoie (FR)

(21) Appl. No.: 11/910,670

(22) PCT Filed: May 30, 2007
(86) PCT No.: PCT/FR2007/051354

§ 371 Date: Nov. 6, 2007

(30) Foreign Application Priority Data
Jun. 5, 2006 (FR) 0652016

(51) Int. Cl. B05D 1/18

(52) U.S. Cl. 427/440

(57) ABSTRACT

Use of a material based on lignocellulose materials, in particular a piece of wood or sawdust, subjected to a process of chemical treatment of said lignocellulose materials, consisting in subjecting said materials to a treatment with a chemical agent comprising hydrocarbon-based chains, this agent being chosen from mixed carboxylic anhydrides, said agent being suitable for ensuring grafting by covalent bonding of a plurality of hydrocarbon-based chains onto said materials, as a material resistant to xylophagous insects.

The present invention relates to the use of a material based on lignocellulose materials, in particular a piece of wood or sawdust, this material having been subjected to a chemical treatment process, as a material resistant to xylophagous insects.

Application WO 03/738219 describes a process for protecting wood which makes it possible to confer on it a hydrophobic nature, in order to increase its durability and its dimensional stability.

Due to this physicochemical treatment, the inventors have discovered, entirely surprisingly and unexpectedly, that the agent grafted by covalent bonding at the surface of the material based on lignocellulose materials (piece of wood, sawdust, or the like) provides these lignocellulose materials with an innocuousness or an increased resistance to an attack by xylophagous insects (termites, Capricorn beetle, hesperophanes, lyctus beetle, furniture beetle, coleoptera, etc.).

The subject of the present invention is thus the use of a material based on lignocellulose materials, in particular a piece of wood or sawdust, subjected to a process of chemical treatment of said lignocellulose materials, consisting in subjecting said materials to a treatment with a chemical agent comprising hydrocarbon-based chains, this agent being chosen from mixed carboxylic anhydrides comprising a first hydrocarbon-based chain RCOOH and a second hydrocarbon-based chain R₁COOH, RCOOH representing a C₂ to C₄ carboxylic acid and R₁COOH being a C₆ to C₂₄ fatty acid, these acids being saturated or unsaturated, said agent being suitable for ensuring grafting by covalent bonding of a plurality of hydrocarbon-based chains onto said materials, as a material resistant to xylophagous insects.

According to another aspect of the invention, it also relates to the use of a chemical agent comprising hydrocarbon-based chains, this agent being chosen from mixed carboxylic anhydrides comprising a first hydrocarbon-based chain RCOOH and a second hydrocarbon-based chain R₁COOH, RCOOH representing a C₂ to C₄ carboxylic acid and R₁COOH being a C₆ to C₂₄ fatty acid, these acids being saturated or unsaturated, said agent being suitable for ensuring grafting by covalent bonding of a plurality of hydrocarbon-based chains onto a material based on lignocellulose materials, in particular a piece of wood or sawdust, for conferring on said material a resistance to xylophagous insects.

By virtue of these arrangements, a material resistant to attacks by xylophagous insects is obtained. In fact, due to the grafting at the level of the hydroxyl bonds by the chemical agent, the xylophagous insects no longer recognize constituents of the starch type, and are no longer attracted by the lignocellulose materials.

Other characteristics and advantages of the invention will become apparent during the following description of one of its embodiments, given by way of nonlimiting example, with regard to the attached drawings.

On the drawings:

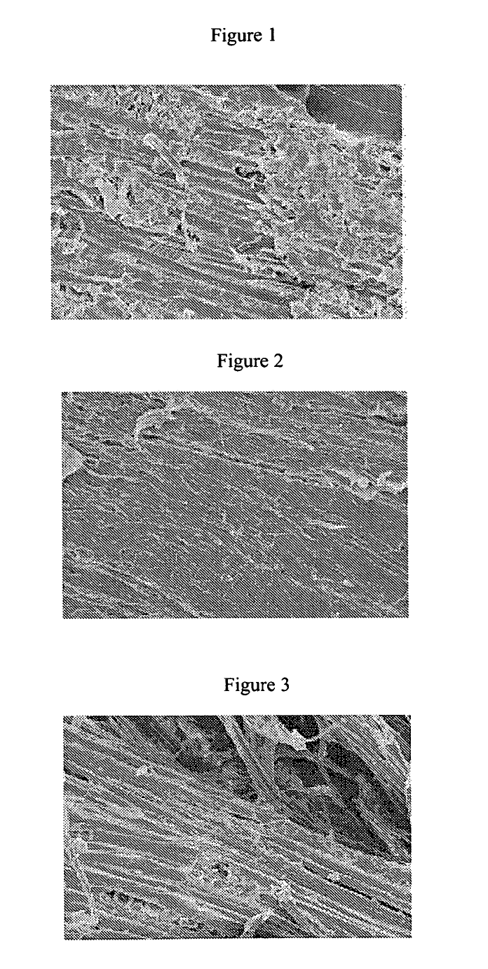

FIG. 1 is a view taken with a scanning microscope (SEM) of an untreated wood sample; it can serve as a reference.

FIG. 2 is a view taken with a scanning microscope (SEM) of a wood sample having undergone the process which is the subject of the invention, in the presence of a strong acid catalyst.

FIG. 3 is another view taken with a scanning microscope (SEM) of a wood sample having undergone the process which is the subject of the invention, in the presence of a strong acid catalyst.

According to a preferred embodiment of the process, the latter consists in impregnating lignocellulose materials, such as in particular at least one piece of wood or sawdust or the like (wood shavings, residues, material based on lignocellulose material (cellulose, hemicellulose)) with a chemical agent comprising hydrocarbon-based chains, said agent being suitable for ensuring grafting by covalent bonding of a plurality of hydrocarbon-based chains onto said materials.

The term “hydrocarbon-based chain” is intended to mean any heteroaliphatic, heteroaromatic, aliphatic or aromatic chain.

This impregnation is carried out at a temperature of between ambient temperature and 150° C., and preferably between 100 and 140° C.

This chemical agent is chosen from organic anhydrides, and preferably from mixed carboxylic anhydrides.

Prior to the phase of impregnation of said lignocellulose materials (for example, at least one piece of wood, sawdust or the like) with the chemical agent, a step of preparation of the mixed carboxylic anhydride is carried out.

According to a first method: using an acid chloride and a carboxylic acid according to the following reaction:

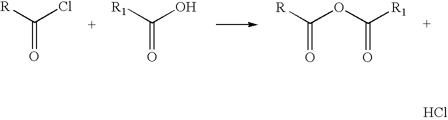

According to a variant of the first method, consisting in exchanging the position of R and of R₁

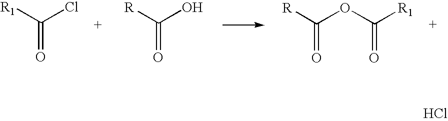

According to a second method: using an acid chloride and a carboxylic acid salt according to the following reaction:

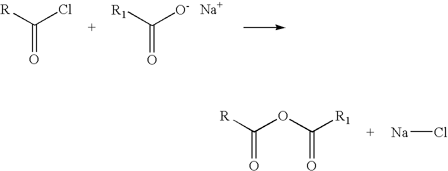

According to a third method: using a linear carboxylic acid anhydride and a fatty acid, according to the following reaction:

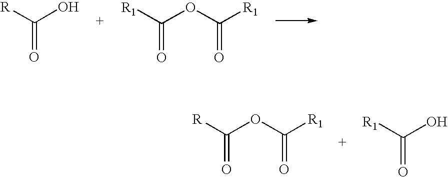

The radicals R and R₁ are aliphatic chains of different lengths. By way of nonlimiting example, it is put forward that R is shorter in length than R₁.

RCOOH represents, for example, a C₂ to C₄ carboxylic acid (acetic, propionic or butyric acid), while R₁ COOH is a C₆ to C₂₄ fatty acid, these acids being saturated or unsaturated (hexylic, octanoic or oleic acid, for example).

The mixed carboxylic anhydrides can be used pure or as a mixture, and in this case, can be derived from a mixture of various carboxylics, from which the synthesis of the desired mixed anhydride is carried out.

Using the mixed carboxylic anhydride obtained by at least one of the methods mentioned above, a piece of wood is then impregnated in such a way as to graft the mixed carboxylic anhydride (for example, acetic/octanoic anhydride) onto said piece of wood, this grafting consisting of an esterification of the wood according to the following reaction:

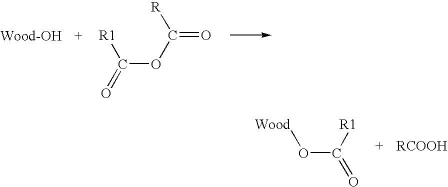

or vice versa with regard to the role between R and R₁

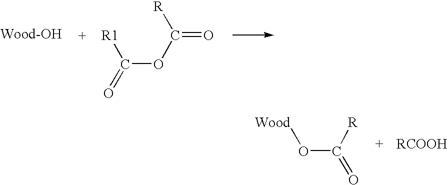

Other esterification methods can also be used according to the reactions envisioned below:

Starting from an acid chloride, this reaction is rapid but the evolution of HCl constitutes a major disadvantage.

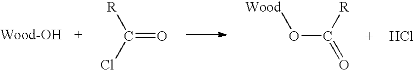

By way of example, the acid chloride is chosen from octanoyl chloride and acetoyl chloride.

Starting from a cetene, the reactants are, however, expensive, which limits the industrial advantage.

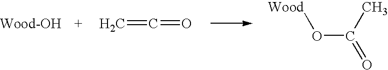

By way of example, this reaction can be combined with, for example, octanoyl chloride.

Starting from carboxylic acids, this reaction nevertheless exhibits a low reactivity and requires the use of coreactants: pyridine, DCC, TsCl, TFAA (DCC: N,N-dicyclohexylcarbodiimide; TsCl: p-toluenesulfonyl chloride; TFAA: trifluoroacetic anhydride).

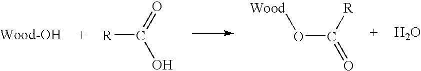

By way of examples, the carboxylic acids used are chosen from acetic acid and octanoic acid.

Starting from carboxylic acid esters (for example methyl octanoate or methyl acetate), it may be noted, however, that, if R consists of CH₃, evolution of (toxic) methanol occurs.

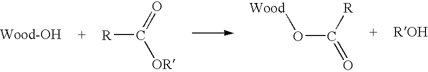

The wood mixed esters can be obtained either
in a single stage, with a mixture of the reactants chosen from those presented above,
or in 2 stages,
   either by using the same type of reaction twice,
   or with two reactions from two different families.

In addition, these esterification reactions can take place in the absence of a catalyst, or with the presence of a basic or neutral catalyst (such as, for example, calcium carbonate, sodium carbonate, potassium carbonate, fatty acid salt, and the like) or with a weak acid catalyst or with a strong acid catalyst, the harmful effects of which on the wood are minimized by the use of very dilute concentrations.

An example of the implementation of the process will be given below:

### EXAMPLE 1

One mole of acetic anhydride was added to one mole of octanoic acid. The mixture was heated with stirring at 140° C. for 30 minutes. A piece of wood with dimensions of 10×10×10 cm was then immersed in the reaction mixture and the combined contents were heated to 140° C. for 1 hour. The piece of wood was then drained and dried in a fan oven.

### EXAMPLE 2

One mole of acetic anhydride was added to one mole of octanoic acid. The mixture was stirred at ambient temperature for 60 minutes. A piece of wood with dimensions of 10×10×10 cm was then immersed in the reaction mixture for 5 minutes and then drained. The piece of wood was introduced into an oven at 120° C. for 1 hour.

A major advantage of the process consists in using a nontoxic mixed carboxylic anhydride of plant origin, as opposed to compounds of petrochemical origin.

This specific choice favors the industrial implementation of the process, since it simplifies the treatments aimed at protecting the environment.

Whatever the treatment process used, it is advisable to be able to find, a posteriori, the signature of this treatment on the lignocellulose material (in our specific case, a piece of wood).

Various methods are envisioned which make it possible to characterize the treatment which the lignocellulose material has been subjected to, namely the determination of the presence of different hydrocarbon-based chains bonded via ester functions and also the presence or absence of a catalyst (and its type).

A method for determining the presence of hydrocarbon-based chains consists in treating a sample originating from the piece of wood with a solution of NaOH in order to hydrolyze the ester functions and to convert the hydrocarbon-based chains to carboxylic acid. The latter are then identified by conventional chromatographic methods, such as HPLC, GC, etc.

An example of these methods can consist in starting from a piece of wood or from a lignocellulose material, the hydroxyl functions of which have been acylated by at least two different hydrocarbon-based agents, giving rise to mixtures of esters, for example acetates and octanoates of lignocellulose material.

This mixture of esters can be characterized in the following way: a sample of wood or of lignocellulose material treated by the claimed process is ground to a particle size of at least 80 mesh and is then introduced into a flask containing an aqueous ethanol solution (70%). After stirring for at least one hour, a sufficient amount of an aqueous NaOH solution (0.5 M) is added and the stirring is continued for 72 h in order to achieve complete saponification of the ester functions. After filtration and separation of the solid residue, the liquid is acidified to pH 3 with an aqueous HCl solution (1 M) in order to convert the hydrocarbon-based compounds to the corresponding carboxylic acids. The liquid can subsequently be analyzed by gas chromatography (GC) or else by high performance liquid chromatography (HPLC) in order to separate and identify the various carboxylic acids corresponding to the ester functions present in the wood or lignocellulose material treated.

Methods for identifying the type of catalyst will be given below.

Thus, a first method consists in determining the amount of extractables. This method makes it possible to observe the influence of the various treatments on the extractables of the wood (initially present or resulting from the decomposition of the wood). The treated and then micronized wood is subjected to extractions with several solvents of different polarities: water, ethanol, acetone and cyclohexane. The extractions are carried out using a Soxhlet device.

The amounts of extractables of the treated wood samples, after extraction in a Soxhlet with various solvents, are collated in the table below.

LOSS in MASS (%) AFTER EXTRACTION

| | Water | Ethanol | Acetone | Cyclohexane |
|---|---|---|---|---|
| Without | 14.8 | 11.9 | 12.2 | 6.3 |
| catalysis | | | | |
| Basic | 17.1 | 16.2 | 10.6 | 1.8 |
| catalysis | | | | |
| Strong acid | 25.3 | 21.7 | 19.0 | 4.8 |
| catalysis | | | | |

As may be seen, whatever the extraction solvent, these results confirm the visual impressions: treatment by strong acid catalysis (0.3 mol % H₂SO₄), which causes the most decomposition and which results in the formation of the largest amount of extractable compounds at the end of the reaction. For large amounts of strong acid (0.3 mol %), the piece of wood darkens and has a tendency to disintegrate and to exhibit defects of appearance.

On the microscopic scale, the cell wall of the fibers is damaged because of the acid catalysis.

Thus, in comparison with FIG. 1, and from a qualitative point of view, it may be observed, with regard to FIG. 2, that the surface of the wood appears to have been smoothed by the treatment, this surface of the wood is homogeneous. The fibers of the wood (lignocellulose fibers) visible under the microscope appear to be intact compared with those in FIG. 1. The product appears, firstly, to have a type of action of stripping the surface, but also enables homogenization of the surface by virtue of the grafting. This is because the grafted chains are capable of protecting the fibers, thereby making it impossible to see them under the microscope.

Likewise with regard to FIG. 3, the lignocellulose fibers appear to be exposed. The presence of product is much less marked than previously (FIG. 2); this is logical as the photograph shows the interior of a block treated by the process of the invention. The shredding is due either to the treatment or, probably, to the tearing of the fibers during cutting.

From a quantitative point of view, a table is given below in which the values of absorption and of swelling for treated and untreated lignocellulose fibers are expressed.

| | Untreated fibers | Treated fibers |
|---|---|---|
| Absorption in % | 16 | 3.5 |
| Swelling in % | 6.5 | 3.5 |

A second method consists in analyzing the constituents of the wood. Depending on the type of medium in which the wood is treated, the biopolymers of the wood do not all undergo the same decompositions. The composition of the treated wood may therefore vary according to the treatment. This method is referred to as the “ADF-NDF” method and it makes it possible to determine the proportions of cellulose C, of hemicelluloses H, of lignins L and of inorganic matter IM.

The data relating to the analysis of the composition of oak wood treated with the acetic/octanoic mixed anhydride with various types of catalysts are collated in the table below. The esterified samples were saponified according to the protocol for the analysis of wood mixed esters and were then washed by extraction with water using a Soxhlet device, before being analyzed by the ADF-NDF technique. This technique is described in the reference (Acid Detergent Fiber, Neutral Detergent Fiber) VAN SOEST P. J. and WINE R. H. Determination of lignin and cellulose in acid-detergent fiber with permanganate. J. As. Offic. Anal. Chem. 51(4), 780-785 (1968).

| Nature of the | | Extractables | | Hemicelluloses | Lignin | Various | |
|---|---|---|---|---|---|---|---|
| treatment | Catalyst | (%) | Cellulose (%) | (%) | (%) | products (%) | Ash (%) |
| Untreated | — | 5.0 | 50.9 | 17.6 | 20.5 | 5.4 | 0.6 |
| wood | | | | | | | |
| Strong | 0.3 mol % | 22.4 | 49.7 | 14.7 | 8.5 | 4.4 | 0.3 |
| acid | H₂SO₄ | | | | | | |
| catalysis | | | | | | | |
| Basic | 0.3 mol % | 16.9 | 40.6 | 16.4 | 20.1 | 5.7 | 0.3 |
| catalysis | Na₂CO₃ | | | | | | |
| Without | — | 12.5 | 41.4 | 17.5 | 17.1 | 10.8 | 0.7 |
| catalysis | | | | | | | |

This analysis therefore makes it possible to distinguish a treatment with strong acid catalysis from the claimed treatments. In fact, a large and significant decrease in the amount of lignin and hemicelluloses is observed. Furthermore, the amount of extractables using the Soxhlet with water is the greatest.

In order to prove the resistance to xylophagous insects, the following experiments were carried out:

Adults of the following families were introduced into a conditioned chamber:
xylophagous insects of dry wood such as coleoptera (lyctus beetle, Capricorn house beetles, etc.) and isoptera,
xylophagous insects of wet wood.

Set up: treated wood and untreated wood put in place→the xylophagous insects systematically move, during the cycles, to the untreated wood.

The same experiment is reproduced by placing only treated wood in the chamber with the same families of insects: the insects die of hunger. The xylophagous insects no longer recognize the starch-type constituents and are no longer attracted by the lignocellulose materials.

What is claimed is:

1. The use of a material based on lignocellulose materials, in particular a piece of wood or sawdust, subjected to a process of chemical treatment of said lignocellulose materials, consisting in subjecting said materials to a treatment with a chemical agent comprising hydrocarbon-based chains, this agent being chosen from mixed carboxylic anhydrides comprising a first hydrocarbon-based chain RCOOH and a second hydrocarbon-based chain R₁COOH, RCOOH representing a C₂ to C₄ carboxylic acid and R₁COOH being a C₆ to C₂₄ fatty acid, these acids being saturated or unsaturated, said agent being suitable for ensuring grafting by covalent bonding of a plurality of hydrocarbon-based chains onto said materials, as a material resistant to xylophagous insects.

2. The use of a chemical agent comprising hydrocarbon-based chains, this agent being chosen from mixed carboxylic anhydrides comprising a first hydrocarbon-based chain RCOOH and a second hydrocarbon-based chain R₁COOH, RCOOH representing a C₂ to C₄ carboxylic acid and R₁COOH being a C₆ to C₂₄ fatty acid, these acids being saturated or unsaturated, said agent being suitable for ensuring grafting by covalent bonding of a plurality of hydrocarbon-based chains onto a material based on lignocellulose materials, in particular a piece of wood or sawdust, for conferring on said material a resistance to xylophagous insects.
